(19) United States
(12) Patent Application Publication
(10) Pub. No.: US 2007/0294473 A1
(43) Pub. Date: Dec. 20, 2007

(54) Navigation method for playback sequence of an optical disc

(75) Inventor: Wiebe De Haan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/580,493

(22) PCT Filed: Nov. 15, 2004
(86) PCT No.: PCT/IB04/52418

§ 371 Date: May 23, 2006

(30) Foreign Application Priority Data
Nov. 27, 2003 (EP) 03104402.7

(51) Int. Cl. G06F 13/00

(52) U.S. Cl. 711/111

(57) ABSTRACT

The invention relates to a method for a playback sequence on an optical disc (100) for controlling access to information (107). The optical disc comprises a navigation structure (104) and content (103). The navigation structure (104) comprises conditional commands, which comprise preconditions. Depending on the precondition, a player always acts (109) to the conditional command in a way predefined in an applicable optical disc standard. The method is able to recognize special preconditions inside conditional commands, so called preset preconditions (111). A player comprising the method can be instructed to act in a different (113) than the predefined way to the conditional command comprising preset preconditions. Implementing conditional commands comprising preset preconditions on an optical disc, results in a behavior of a player comprising the method being different from a player not comprising the method. This can be used to control access to information (107) on the disc (100).

The invention relates to an optical disc comprising a content and a navigation structure, the navigation structure comprising commands from a set of navigation commands for controlling a playback sequence of the content, the set of navigation commands comprising conditional commands for controlling the playback sequence in a predefined way depending on a precondition related to a playback status, the content comprising a first information being freely accessible and a second information being accessible dependent on the precondition in a preceding conditional command.

The invention further relates to a method for performing a playback sequence from the optical disc, to a player for performing a playback sequence from the optical disc, to an optical disc recorder for recording a content and a navigation structure onto the optical disc, and to a computer program product for recording information.

Access control to information stored on an information carrier is known from the U.S. Pat. No. 5,724,472. In this patent, a method to reshape the content of a video originating from a single source is disclosed. Through the ability to reshape the content, access to parts of the video unsuited for some of the viewers is controlled. The source comprises a plurality of video segments and a navigation structure. The plurality of video segments are associated with a pre-established content category. The reshaped video, also called playback sequence, is created by defining a content map, which is a listing of video segments to be displayed sequentially. During reshaping of the content a new content map is created, only comprising segments associated with the chosen preestablished content category. The sum of these chosen segments still results in a complete story. The navigation structure comprises all necessary information for a player to be able to display a chosen selection of the content, such as separate listings of commands or single commands as part of the video. Because the locations of the plurality of video segments on the source are likely to be scattered, a buffer is necessary to consolidate the new content map and display a seamless version of the video, which may differ in length from the original video. The access is controlled by the user, for example a parent, who can define a specific playback status in the optical disc player, which limits the access to another preestablished content category. This enables the user to exclude, for example, segments which he does not like or which are not suited for younger viewers from the video.

Optical disc players and discs are created according to well known standards like DVD. The method described above is currently implemented in some of these standards and is called ‘parental control’. The content basically comprises of first information, being information which is freely accessible and second information, being information which is accessible dependent on a precondition. Thereto the second information is preceded by a conditional command, the so called preceding conditional command, which is part of the set of conditional commands as they are defined in the optical disc standards. The preceding conditional command is logically processed before accessing the second information. The preceding command is part of the navigating structure, and may be stored separately, for example within a listing of navigation commands. The standard also predefines what action will be performed by the optical disc player when it encounters a conditional command. Access to the second information is thus depending on the preceding conditional command in combination with the precondition of that preceding conditional command.

It has been observed that the means for shaping the content or restricting the access to certain parts of the content are controlled by the user.

It is an object of the invention-to provide a navigation method in which more flexible access restrictions are made available.

A first aspect of the invention provides a navigation method for performing a playback sequence from an optical disc comprising a content and a navigation structure,

the navigation structure comprising commands from a set of navigation commands for controlling the playback sequence of the content, the set of navigation commands comprising conditional commands for controlling the playback sequence in a predefined way depending on a precondition being related to a playback status,

the content comprising a first information being freely accessible and a second information being accessible dependent on the precondition in a preceding conditional command,

the method comprising:

playing back the content according to the navigation commands,

recognizing a preset precondition that is unrelated to the playback status,

acting in a way different from the predefined way upon the preceding conditional command that comprises said preset precondition for controlling access to the second information.

A second aspect of the invention provides an optical disc comprising a content and a navigation structure,

the navigation structure comprising commands from a set of navigation commands for controlling a playback sequence of the content, the set of navigation commands comprising conditional commands for controlling the playback sequence in a predefined way depending on a precondition related to a playback status,

the content comprising a first information being freely accessible and a second information being accessible dependent on the precondition in a preceding conditional command,

the preceding conditional command comprises a preset precondition for controlling access to the second information, the preset precondition being unrelated to the playback status.

The method in accordance with the first aspect of the invention comprises the recognition of a preset precondition. The preset precondition is a precondition which is defined such that it is unrelated to the playback status. This means that the result of the preset precondition is fixed and not depending on the playback status of the playback device as defined for controlling the playback sequence.

Because the preset precondition is fixed, it always returns the same result to the optical disc player, which then acts to the preceding conditional command in the predefined way, for example defined in the appropriate optical disc standard. Hence such conditional command is a dummy condition. The optical disc player according to the invention recognizes the preset precondition and is instructed to perform a different action in respond to the preceding conditional command than predefined in the optical disc standard.

The effect of the method is that players which do not have the ability to recognize the preset preconditions, for example ‘legacy’ players, always perform a predefined behavior when they encounter a preceding conditional command comprising a preset precondition. Players which have the ability to perform the method in accordance with the invention recognize the preset precondition and behave in a way different from the predefined way to the preceding conditional command comprising a preset precondition.

The advantage of the method in accordance with the invention is that it offers an additional way for controlling access to parts of the content of an optical disc. It enables the manufacturers of optical discs to shield off part of the content and create a navigation structure around the shielded information, only enabling access to the shielded information under certain conditions.

The recognition that limited access to part of the information can be achieved through encryption of that part of the content of the disc has lead to encrypted optical discs. Playback of encrypted optical discs on ‘legacy’ players would cause ‘legacy’ players to behave in an undefined way, when the ‘legacy’ player attempts to display the encrypted content Access to the encrypted content on an encrypted optical disc can be controlled by using preceding conditional commands that comprises preset preconditions. These preceding conditional commands can be constructed such that the ‘legacy’ player is always navigated away from the encrypted content of the optical disc. Applying the method to an encrypted optical disc will prevent the ‘legacy’ player from behaving in an undefined way.

In an embodiment of the optical disc, the optical disc is a partially encrypted optical disc, which comprises both encrypted and non-encrypted information. The arrangement of dummy conditions on the optical disc can be such that ‘legacy’ players are navigated away from the encrypted content. Shielding the encrypted content from the ‘legacy’ player prevents the ‘legacy’ player from behaving in an undefined way.

In an embodiment of the optical disc, the preceding conditional command is a non-operative button command. A standard button command, being part of the navigation commands as defined in the optical disc standard, is operative during an active-period. During that active-period a button is displayed on which a user can react and give inputs to the player and thus change the playback status of the player. Hence, the action which results from the standard button command is depending on the playback status of the player. If the user does not give inputs during the active-period that the button command is active, a predefined way, e.g. auto-activate may occur, which may be a stop until there is input or a different defined action such as a jump. The active-period during which the standard button command is operative constitutes the precondition of the standard button command. Reducing the time that the button is operative to zero, creates a non-operative button command. The non-operative button command performs the predefined action regardless of the playback status. The method according to the invention recognizes the non-operative button command from the standard button commands via the active-period during which the button is operative, which is substantially zero. The effect of the non-operative button command is that ‘legacy’ players always perform the predefined way when they encounter the non-operative button command. Optical disc players that are able to recognize the preset precondition behave in a way different from the predefined way to a non-operative button command. The benefit of this embodiment is that the non-operative button command may be used both in the content of the optical disc and in the navigation structure.

In an embodiment of the optical disc, the content to which the access is controlled through dummy conditions is mixed with content which is freely accessible. This mixing of contents reduces the number of jumps that the reader unit from an optical disc player must do when the playback sequence comprises both controlled content and freely accessible content.

In an embodiment of the optical disc, the optical disc comprises an identification which indicates that preset preconditions are used within the navigation structure of the disc. The player uses the identification to activate the means to recognize dummy conditions within the navigation structure. This prevents the means for recognizing dummy conditions from being active constantly. It further prevents falsely recognizing conditional commands as being dummy conditions and thus falsely acting different than predefined in the optical standard to the conditional command.

A third aspect of the invention provides a player for performing a playback sequence from an optical disc comprising a content and a navigation structure,

the navigation structure comprising commands from a set of navigation commands for controlling the playback sequence of the content, the set of navigation commands comprising conditional commands for controlling the playback sequence in a predefined way depending on a precondition related to a playback status,

the content comprising a first information being freely accessible and a second information being accessible dependent on the precondition in a preceding conditional command,

the player comprising a reader unit for reading data including the navigation structure and the content from the optical disc,

means for receiving user inputs for defining the playback status,

a control unit for receiving the data from the reader unit and for combining the content and the navigation structure to generate the playback sequence,

means for recognising a preset precondition being unrelated to the playback status, and

means for acting in a way different from the predefined way upon the preceding conditional command that comprises said preset precondition for controlling access to the second information. As described above, the conditional command comprising a preset precondition is a dummy condition. The action that a player needs to perform upon a conditional command is predefined in an applicable optical disc standard. The player which can recognize a preset precondition further comprises means to react differently to the conditional command comprising the preset precondition than predefined in the applicable optical disc standard. The result is that players which can recognize the preset preconditions act differently to optical discs that comprise dummy conditions than players which do not recognize the preset preconditions.

In an embodiment of the player, the means for acting in a way different from the optical standard is enabled through the use of an identification code or through the use of a key. As is explained in embodiments of the optical disc, the identification code or key prevents the means for recognizing dummy conditions from being active constantly. It further prevents falsely recognizing conditional commands as being dummy conditions and thus falsely acting different than predefined in the optical standard to the conditional command.

In an embodiment of the player, the access-controlled content is encrypted and the player comprises means for decrypting the content.

A fourth aspect of the invention provides an optical disc recorder for recording a content and a navigation structure onto an optical disc,

the navigation structure comprising commands from a set of navigation commands for controlling a playback sequence of the content, the set of navigation commands comprising, conditional commands for controlling the playback sequence in a predefined way depending on a precondition related to a playback status of an optical disc player,

the content comprising a first information being freely accessible and a second information being accessible dependent on the precondition in a preceding conditional command,

the optical disc recorder comprising a recording unit for recording data onto the optical disc, the data comprising the content and the navigation structure,

a control unit for receiving input data comprising the content, and generating the navigation structure,

means for recognising the second information, the control unit being arranged for including a preset precondition in the preceding conditional command in the navigation structure for controlling access to the second information, the preset precondition being unrelated to the playback status of the optical disc player. The means for recognizing determine whether input data is to be recorded as second information, i.e. content for which access control is required. For example the input data comprises coding through which the optical disc recorder can recognize the second information. The control unit of the optical disc recorder will then include preceding conditional commands comprising preset preconditions in the recorded navigation structure. Through including preset preconditions in the preceding conditional commands, access control to the second information can be implemented.

In an embodiment of the optical disc recorder, the optical disc recorder comprises means for encrypting the access-controlled content. When not the complete content of the optical disc needs access control, encryption of the access-controlled content results in partially encrypted optical discs. By adding dummy conditions to the navigation structure, ‘legacy’ players can be prevented to reach this encrypted content and still reach the freely accessible content.

A fifth aspect of the invention provides a computer program for recording information, which program is operative to cause a processor to perform the method as described in the first aspect of the invention.

Advantageous embodiments are defined in the dependent claims.

These and other aspects of the invention are apparent from and will be elucidated with reference to the drawings:

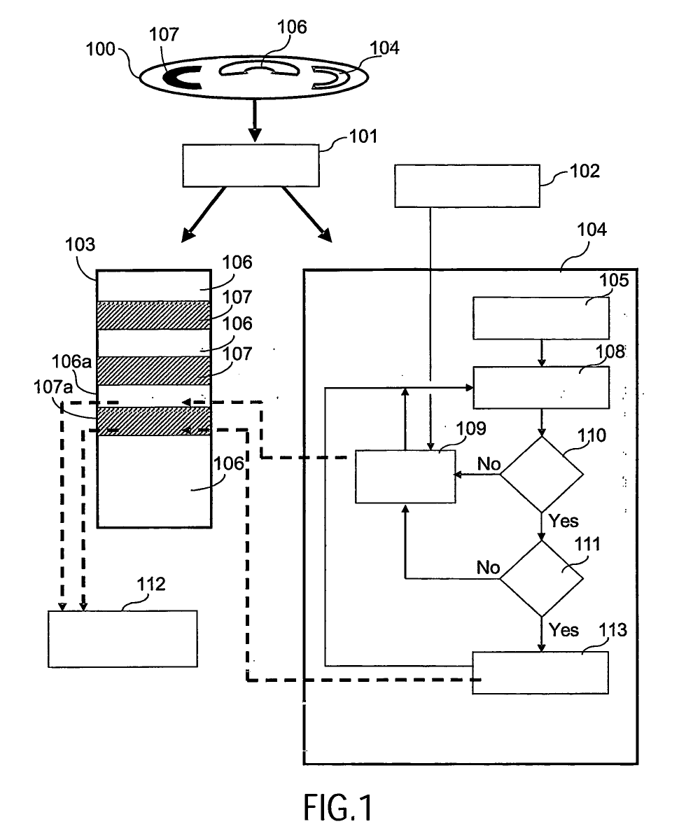

FIG. 1 shows a flow diagram of the method according to the invention

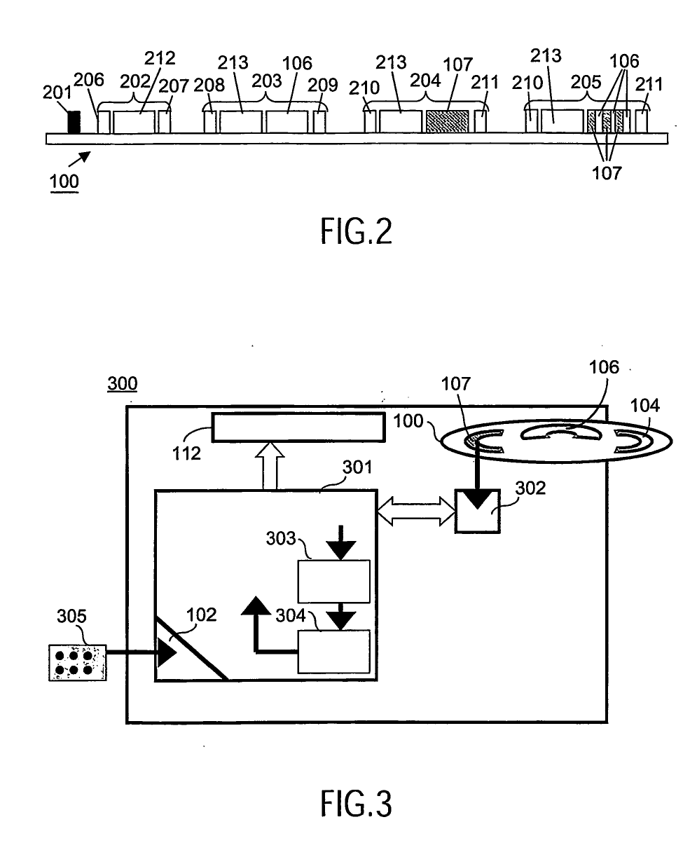

FIG. 2 shows the data structure on an optical disc

FIG. 3 shows the schematics of a player able to recognize preset preconditions

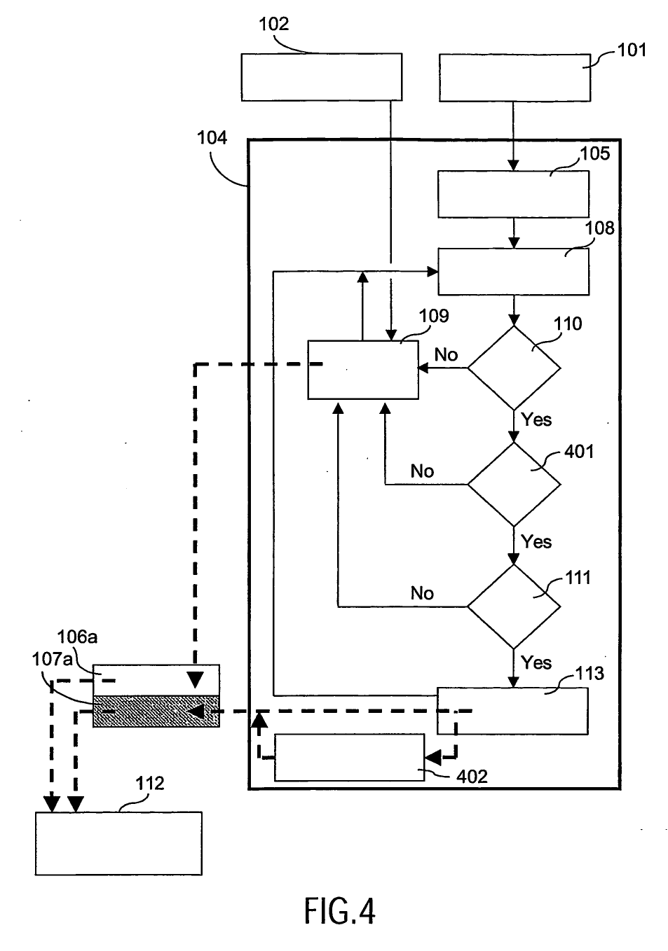

FIG. 4 shows a flow diagram with an additional key or identification code check and decryption option

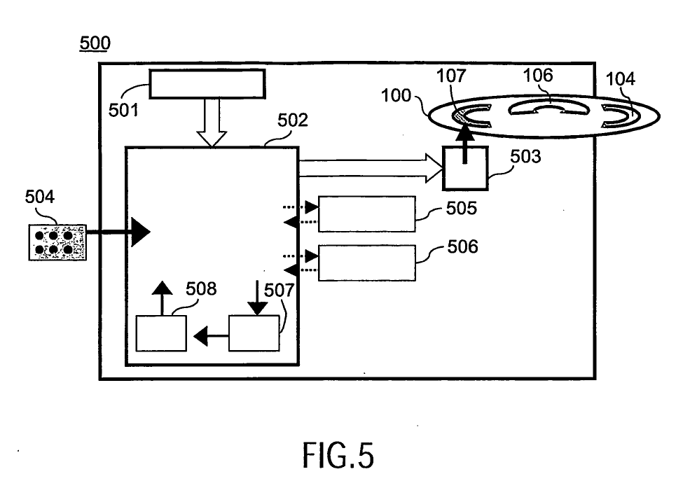

FIG. 5 shows the schematics of an optical disc recorder able to implement preset preconditions

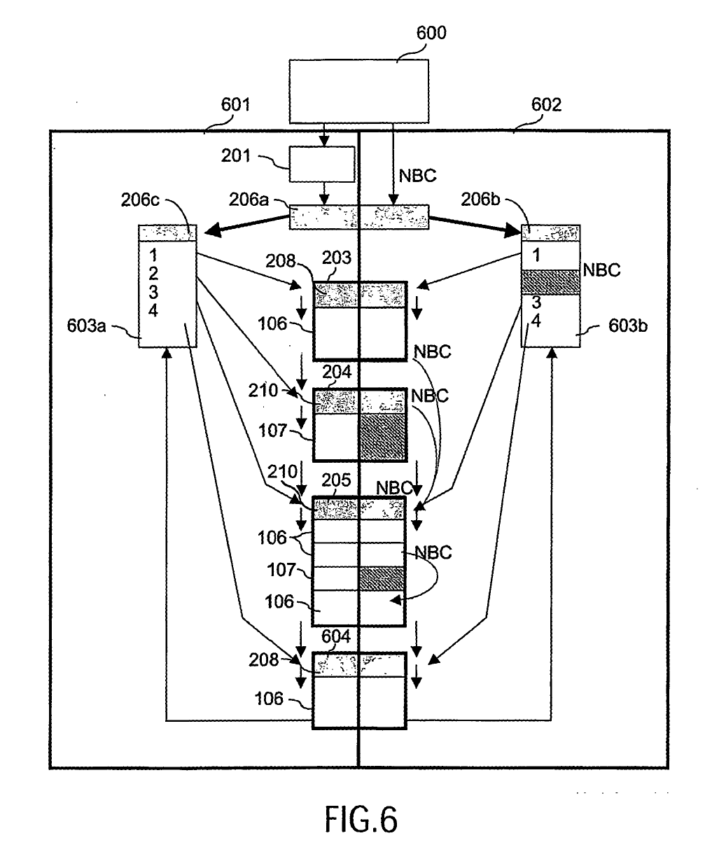

FIG. 6 shows an implementation example on a partially encrypted DVD

The figures are schematic and not drawn on scale. Generally, identical components are denoted by the same reference numerals in the figures.

FIG. 1 shows a flow diagram of the method according to the invention. The read data 101 (READ DATA), which is retrieved from an optical disc 100 (OPTICAL DISC), comprises content 103 (CONTENT) and a navigation structure 104 (NAVIGATION STRUCTURE). The content 103 comprises freely accessible content, so called free content 106 (FREE CONTENT) and content where the access is depending on navigation commands, so called controlled content 107 (CONTROLLED CONTENT). The navigation structure 104 comprises command sequences and look-up tables, through which a reader unit 302 (READER UNIT) within a player 300 (PLAYER) (FIG. 3) is directed to different locations on the optical disc 100 for reading part of the content from the disc. A control unit 303 (CONTROL UNIT) within the player 300 will connect these different content parts into a sequence, the so called playback sequence 112 (PLAYBACK SEQUENCE). When the optical disc is a DVD, the control unit 303 within the player 300 will connect different parts of the video-content together to form a complete video. Which parts of the content 103 are included in the playback sequence 112 depends on the commands in the navigation structure 104. The commands that can be used and which action the player 300 performs upon encountering such command is predefined in an optical disc standard. Access control to controlled content 107 is already done with a subset of the navigation commands. An example, being parental control, has been shown in the prior art. However, the decision which part of the content is accessed is taken by the user of the player 300.

The invention relates to a method for controlling the access to controlled content 107 on an optical disc via using special preconditions in standard conditional commands. These special preconditions can be recognized by the method and responded to in a way different from the predefined way in the optical standard. The feature which makes the precondition special is that it is preset, indicating that the outcome of the precondition is not depending on input from the user, said input serving e.g. to activate the so called playback status 102 (PLAYBACK STATUS) of the player 300. An example of a conditional command comprising a preset precondition is a ‘compare and jump’ command and when used on a DVD this could look like:

IF(PRM[CP1]=PRM[CP2])THEN JUMPTT( )

where CP1=CP2=15

Because the precondition inside the ‘IF’-statement is always true, the JUMPTT-command, Jump-To-Title, is always performed. The precondition (PRM[CP1]=PRM[CP2]) is preset and can be recognized by the method. A player 300, able to recognize that the precondition is preset, for example, through a sub-routine analyzing the commands in the navigation structure 104 as indicated in FIG. 1, is instructed to ignore the JUMPTT command and move to a next command. The next command will instruct the reader unit 302 of the player 300 to move to the location where the shielded content (controlled content 107) is stored on the disc and read the content and include it into the playback sequence 112. There are of course several ways to implement the ‘compare and jump’ commands on a disc. In one example the controlled content is a movie and the movie is only accessed when the player 300 is able to recognize preset preconditions. In another example, the controlled content is advertisement. The player 300, which is not able to recognize preset preconditions, always shows the advertisement. The player 300, which is able to recognize preset preconditions jumps over the advertisements and only shows the movie.

The first step in the method is indicated with analyze commands 105 (ANALYSE COMMANDS). The next step ‘conditional command?’ 110 (CONDITIONAL COMMAND?) in the method is to check if the command is a conditional command. If the command is not a conditional command, the method moves to step action 109 (ACTION) and starts acting upon the navigation command as defined in the optical disc standard. The action defined in step action 109 may imply that the reader moves to a certain location on the disc and retrieves a part of the free content 106a which will be added to the playback sequence 112. After the action defined in step action 109 has been performed, the method moves back to step next command 108 (NEXT COMMAND). Again the step ‘conditional command?’ 110 checks if the command is a conditional command. If the command is a conditional command, the method moves to step ‘precondition preset?’ 111 (PRECONDITION PRESET?) to check if the precondition of the conditional command is a so-called preset precondition as described in the examples above. The result of the preset precondition is fixed and not depending on the playback status 102 of the playback device. If the precondition of the conditional command is no preset precondition, the method moves again to step action 109 and starts acting upon the navigation command as defined in the optical standard. The playback status 102 of the player 300 will be used as input for the step action 109. Again, this may imply that another part of the free content 106 will be included in the playback sequence 1 12. The method then returns again to step next command 108. If the precondition of the conditional command, which is checked in step precondition preset 111, is a preset precondition, the method moves to step different action 113 (DIFFERENT ACTION). This will cause the method to act different to the conditional command than defined in the optical disc standard. In the example, the player 300 is instructed to ignore the Jump-To-Title command and move to the next command. The action defined in step different action 113 may imply that the reader moves to a location on the disc which is usually shielded from access and retrieves a part of the controlled content 107a. This controlled content 107a will then be added to the playback sequence 112. The action as defined in step different action 113 is not depending on the playback status 102. The method returns to step next command 108 and repeats this sequence until the complete command sequence has been dealt with. In parallel, the playback sequence 112 is sent to be displayed.

FIG. 2 shows the data structure on an optical disc 100. The main structure comprises data for setting up and controlling the menu, the so called VMG 202, and several sets of video titles called VTS#1 203, VTS#2 204 and VTS#3 205. A set of video titles VTS#n may comprise a single video title or a set of video titles. Each of these blocks of data or files comprises navigation commands, video images and back-up navigation commands. For the VMG 202, the navigation commands to generate and control the optical disc menu are located at the VMGI 206 comprising several program chains through which the navigation on the disc is controlled. The video images that may be used in the menu are located in the VMGM_VOB 212. The back-up-VMGI 207 completes the content of the VMG 202. For the sets of video titles VTS#1 203, VTS#2 204 and VTS#3 205, the navigation commands are located at the VTSI 208, 210 and support additional menu options for each of the sets of titles. The VTSI 208 of VTS#L 203 comprises navigation commands which are used when the set of video content is freely accessible. The video images that may be used in the menus of the VTS#n 203,204, 205 are located in the video content VTSM_VOB 213. The VTSI 210 of both the VTS#2 204 and VTS#3 205 comprise additional navigation commands with which the access to the sets of videos or to part of the sets of videos is controlled. The actual sets of video streams is located in the VTSTT_VOB 106, 107, where each of the VTS#n can contain several video titles. The VTS#1 203 comprises freely accessible sets of information (free content 106). The VTS#2 204 comprises sets of information where the access is controlled from the complete set of video-title content (controlled content 107). The VTS#3 205 comprises a mix of both freely available sets of information (free content 106) and sets of information from which the access is controlled (controlled content 107). Finally a back-up of the set of navigation commands, back-up-VTSI 209, 211, completes the content of the different sets of video titles VTS#1 203, VTS#2 204 and VTS#3 205. On recordable discs an additional set of data is present right at the center of the optical disc. For the DVD+RW standard, the additional set of data is called VRMI 201 and comprises data structures for supporting the video recording process. Furthermore, the sequence of the files as described above can be different for recordable or rewritable discs.

Preceding condition commands comprising preset preconditions, like the ‘compare and jump’ command discussed earlier, may be located in several command sequences on the disc. In the menu, the VMGI 206, the ‘compare and jump’ command is able to shape the menu of the optical disc such that the access to the controlled content is shielded from the user. The user simply cannot select the shielded sets of video titles in the menu. Only a player 300 which recognizes the preset precondition will give the user access to the shielded sets of video titles. Also in the command sequence VTSI 210 of the two sets of video titles VTS#2 204 and VTS#3 205 a ‘compare and jump’ command can control the access to the controlled content 107. The access to the complete set of titles VTS#2 204 can be blocked for players which do not recognize preset preconditions. In the command sequence of the VTS#3 205 the ‘compare and jump’ command should shield only that part of the content comprising controlled content 107. A copy of these preceding conditional commands is of course located in the back-up of each of these command sequences in the back-up-VTSI 207, 211.

In an embodiment of the invention, a preceding conditional command comprising a preset precondition is included in a button command. For example, a standard button command comprises position information, adjacent button information and a command field. The command field of the button command may comprise any command. By including the preceding conditional command access to part of the information can be controlled. The additional feature that button commands offer is that they may be located directly inside the video content located in front of the information of which the access is to be controlled (controlled content 107).

In another embodiment of the invention, non-operative button commands NBC (FIG. 6) are used as preceding conditional commands for controlling access to part of the information. The standard button command is operative during an active-period and displays a button on which the user can react. The active-period during which the standard button command is operative constitutes the precondition of the button command. The button command can be used to navigate through the content of the optical disc, for example move to a different title or give the user temporarily the option to view the current images from a different angle. A button command where the active-period in which it is operative is substantially zero is called a non-operative button command NBC. A player 300 which is able to recognize preset preconditions is able to recognize non-operative button commands (NBC) via the active-period which is substantially zero. The non-operative button commands may also be located directly inside the video content located in front of the information of which the access is to be controlled (controlled content 107).

In another embodiment, the information from which the access is being controlled (controlled content 107) may be encrypted information and may be mixed with freely accessible or non-encrypted information (free content 106).

In another embodiment the optical disc comprises an additional identification code 401 (IDENTIFICATION CODE) (FIG. 4), located on a predefined location on the disc. The identification code 401 indicates that the disc comprises preceding conditional commands, for example ‘compare and jump’ commands or non-operative button commands (NBC). An obvious location for the identification code would be in the VRMI 201.

FIG. 3 shows the schematics of a player 300 (PLAYER) able to recognize preset preconditions. The player 300 comprises a reader unit 302 (READER UNIT) with which data is retrieved from the optical disc 100 and which is connected to a controller unit 301 (CONTROLLER UNIT). The controller unit 301 is arranged for receiving the data as read by the reader unit 302 and converts the content into a sequence, the so called playback sequence 112, taking the playback status 102 into account. The data comprises free content 106 and the navigation structure 104. The controller unit 301 interprets the navigation commands from the navigation structure 104 and instructs the reader unit 302 to move to the indicated locations on the disc and read the parts of the free content 106. The parts of the content that have been read, will be chained by the controller unit 301 into a sequence, the so called playback sequence 112. A player 300 which is able to recognize preset preconditions, can in addition access the shielded information (controlled content 107) and add this content to the playback sequence 112. Recognition of the preset preconditions is done through analysis of the navigation structure 104. This analysis is done for example via a sub-routine inside the controller unit 301 indicated with ‘preset?’ 303 (PRESET?). Once the player encounters a preset precondition, like the previously mentioned ‘compare and jump’ command or like the non-operative button commands NBC, it acts differently on the conditional command than is predefined in the optical disc standard. The acting different on the conditional commands, different from the optical disc standard, is stored in another part of the controller unit 301 indicated with act 304 (ACT DIFFERENT). As explained before, one example of acting differently to the ‘compare and jump’ command is skipping the controlled content 107, like removing advertisements from a movie when the customer pays an additional fee. It may also be accessing the controlled content 107, when the controlled content 107 is the actual movie and access to the movie is controlled by a conditional command comprising a preset precondition.

In an embodiment, the sub-routine for recognizing a preset precondition is not active constantly. Activating the sub-routine to start analyzing the navigation structure 104 is in one example done via an identification code located on the disc. This identification code is read by the reader unit 302 together with the rest of the data and interpreted by the controller unit 301 to activate the sub-routine. In another example some kind of number-key, supplied to the user and through, for example, a remote control inserted into the player, is used to indicate to the controller unit 301 that the optical disc comprises ‘compare and jump’ commands or non-operative button commands NBC. This activates the sub-routine.

FIG. 4 shows a flow diagram with an additional key or identification code check and decryption option. The initial part of the flow runs parallel to the description of the method in FIG. 1 until a conditional command 110 is reached. There, an additional step has been added ‘identification code/key?’ 401 (IDENTIFICATION CODE/KEY?). This step, for example, once executed instructs the reader unit 302 to move to a certain location on the disc and to read the identification code which is located there and compares it with codes located in the memory of the player 300. In another example, the player 300 requests a number-key to be supplied by the user via, for example, the remote control. Of course the combination of the two examples is also possible, where the player 300 compares the number-key, supplied by the user with an identification code read from the disc. If the disc contains an additional identification code or if the correct number-key has been supplied, the player 300 continues with the rest of the sub-routine, searching for preset preconditions, as explained in FIG. 3. This feature prevents the sub-routine which recognizes preset preconditions from being active constantly and allows further access control. It further prevents falsely recognizing conditional commands as being preset preconditions and thus falsely acting different than predefined in the optical standard to the conditional command.

In FIG. 4 an additional embodiment is shown where the different action 113 triggers a decryption algorithm 402 (DECRYPTION). This embodiment can be implemented in a player 300 for decrypting the controlled content 107 before being added to the playback sequence 112. A combination of the two embodiments, shown in FIG. 4 results in a player where the preset precondition is recognized only when the disc comprises an identification code or when the correct number-key has been supplied to the player 300. Only then the controlled content 107 is decrypted.

FIG. 5 shows the schematics of an optical disc recorder 500 (OPTICAL DISC RECORDER) able to implement preset preconditions. The optical disc recorder 500 comprises a recorder unit 503 (RECORDER UNIT) which is connected to a control unit 502 (CONTROL UNIT). The control unit 502 is arranged for receiving input data 501 (INPUT DATA) and for converting this data, after considering the user input 504 (USER INPUT), into a free content 106 and a navigation structure 104 which is recorded on the optical disc 100. When the input data 501 or part of the input data 501 needs access control, the optical disc recorder 500 includes preset preconditions in the conditional commands. The conditional commands comprising preset preconditions can be added to the navigation structure 104, for example, via additional software inside the control unit 502, which is linked to a listing of possible preset preconditions. This additional software is identified in FIG. 5 via the block ‘included preset preconditions’ 508 (INCLUDED PRESET PRECONDITIONS). The recognition of the content which needs access control is done through codes in the input data 501 or through user inputs 504. The user, for example, indicates before recording starts that the data needs to receive access control. The additional software, with which the input data 501 is scanned for codes, indicating that the content needs access control, is shown in FIG. 5 via the block ‘content controlled?’ 507 (CONTENT CONTROLLED?). The part of the input data 501 of which the access is being controlled is stored on the disc as controlled content 107.

In an embodiment of the optical disc recorder 500 as shown in FIG. 5, the optical disc recorder 500 also encrypts the controlled content 107 through encryption software before the content is recorded on the disc. The encryption software is indicated in the FIG. 5 via the block ‘encryption’ 505 (ENCRYPTION).

In another embodiment of the optical disc recorder 500 as shown in FIG. 5 an identification code is added to the disc. This code indicates that the disc contains controlled content 107 and that conditional commands are present comprising preset preconditions. The identification code can be added via another sub-routine or software which instructs the control unit 502 to move the recorder unit 503 to a predefined position and record the code on the disc. The sub-routine for adding the identification code is indicated in FIG. 5 with ‘identification’ 506 (IDENTIFICATION).

FIG. 6 shows an implementation example on a partially encrypted DVD 600 PARTIALLY ENCRYPTED DVD). The partially encrypted DVD 600 comprises controlled content 107 together with free content 106. FIG. 6 shows how a legacy player 602 (LEGACY PLAYER) is navigated away from the controlled content 107, using preceding conditional commands comprising preset preconditions. It further shows an enabled player 601 (ENABLED PLAYER) enabling access to the controlled content 107 by acting different to the preceding conditional commands than predefined in the DVD standard. The arrows show possible navigational moves. FIG. 6 further only shows the command sequences of the menu VMGI 206 and of the different sets of video titles VTSI 208, 210, and the video content VTSTT_VOB 106, 107 in each of the sets of video titles. The video images that may be used in the menus, the VMGM_VOB 212 and the VTSM_VOB 213, are omitted, as are the back-up navigation structures back-up-VTSI 207, 211. The legacy player 602 first encounters the so called first play PGC 206a (FIRST PLAY PGC), which is part of the command sequence of the menu VMGI 206. This command sequence will be executed immediately after the disc is loaded. The legacy player 602 will perform the preceding conditional command in the first play PGC 206a and will move to the legacy menu 603b (LEGACY MENU). This menu does not give access to the set of video titles VTS#2 204, which only comprises controlled content 107, but it will give access to the other sets of video titles VTS#1 203, VTS#3 205 and VTS#4 604. The legacy menu 603b is built with the legacy navigation 206b (LEGACY NAVIGATION) command sequence. The controlled content 107 is now not accessible from the main DVD menu, but additional preceding conditional commands comprising preset preconditions are necessary to securely shield the controlled content 107 from the user. Within the command structure of the first title, preceding the shielded content, an additional preceding conditional command comprising preset precondition should be added as a next title command. The next title command ensures that the next title is played immediately after the current title has ended. The next title command comprising preset precondition ensures that the legacy player 602 jumps over shielded VTS#2 204, when it reaches the end of the first video title VTS#1 203. Still, in the command structure of the shielded set of video titles VTS#2 204 also additional preceding conditional commands comprising preset preconditions are necessary to ensure that the legacy player 602 jumps over the shielded VTS#2. This additional command is necessary because the DVD player can be instructed to directly play a specific video title, without selecting it in the legacy menu 603b. Within the set of video titles VTS#3 205 only part of the sets of titles comprises controlled content 107. The preceding conditional commands comprising preset preconditions are located within the command u ceVTSI 210 of the sets of video titles, ensuring that the legacy player jumps over that part of the sets of video titles VTS#3 which is controlled content 107. The enabled player 601 will act differently to the preceding conditional command in the first play PGC 206a, showing the viewer the enabled menu 603a (ENABLED MENU) where the sets of video titles VTS#2 204 comprising controlled content 107 is freely accessible next to all other video titles. The enabled menu 603a is built with the enabled navigation 206c (ENABLED NAVIGATION) command sequence. Also other preceding conditional commands distributed on the partially encrypted DVD 600 will be recognized by the enabled player 601. These preceding conditional commands for navigating the legacy player 602 away from the controlled content 107 will initiate a different action from the enabled player 601 and will enable access to the controlled content 107. FIG. 6 also shows the possibility that the partially encrypted DVD 600 comprises an identification code 401, which could be located in the VRMI 201 on the disc. This identification code 401 activates the additional programming used for recognizing the preset precondition (preset? 303) in the player. Also indicated in FIG. 6 are the locations of possible non-operative button commands NBC to shield the controlled content 107 from being accessed by the legacy player 602. At these locations also standard button commands comprising a preceding conditional command in the command field can be used for shielding the controlled content 107. The enabled player 601 will react to the non-operative button commands NBC and to the button commands comprising a preceding conditional command in the same way as described above to the other preceding conditional commands comprising preset preconditions.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method for performing a playback sequence (112) from an optical disc (100) comprising a content (103) and a navigation structure (104),
the navigation structure (104) comprising commands from a set of navigation commands for controlling the playback sequence (112) of the content (103), the set of navigation commands comprising conditional commands (110) for controlling the playback sequence (112) in a predefined way (109) depending on a precondition being related to a playback status (102),
the content (103) comprising a first information (106) being freely accessible and a second information (107) being accessible dependent on the precondition in a preceding conditional command,
the method comprising the steps of:
playing back the content (103) according to the navigation commands,
recognizing a preset precondition (111) that is unrelated to the playback status (102),
acting in a way different from the predefined way (113) upon the preceding conditional command that comprises said preset precondition (111) for controlling access to the second information (107).

2. An optical disc (100) comprising a content (103) and a navigation structure (104),
the navigation structure (104; 201, 206, 208, 210) comprising commands from a set of navigation commands for controlling a playback sequence (112) of the content (103), the set of navigation commands comprising conditional commands (110) for controlling the playback sequence (112) in a predefined way (109) depending on a precondition related to a playback status (102),
the content (103) comprising a first information (106) being freely accessible and a second information (107) being accessible dependent on the precondition in a preceding conditional command,
the preceding conditional command comprises a preset precondition (111) for controlling access to the second information (107), the preset precondition (111) being unrelated to the playback status (102).

3. An optical disc (100) as claimed in claim 2, characterized in that the first information (106) is non-encrypted information and that the second information (107) is encrypted information.

4. An optical disc (100) as claimed in claim 3, characterized in that the preset precondition (111) in the preceding conditional command is arranged for shielding encrypted information from being accessed.

5. An optical disc (100) as claimed in claim 2, comprising a button command being a command from the set of navigation commands that is operative during an active-period in which a user input (305) can set the playback status,
the button command acting in the predefined way depending on the playback status,
the active-period constituting the precondition of the button command, characterized in that the preceding conditional command comprising a preset precondition is a non-operative button command (NBC) for controlling the access to the second information, the precondition being preset by the active-period being substantially zero.

6. An optical disc (100) as claimed in claim 2, characterized in that the first information (106) and the second information (107) are mixed (204; 205) on the disc (100).

7. An optical disc (100) as claimed in claim 2, characterized in that the optical disc (100) comprises identification code (201, 401) to indicate that the optical disc (100) contains preset preconditions (111).

8. A player (300) for performing a playback sequence (112) from an optical disc (100) comprising a content (103) and a navigation structure (104),
the navigation structure (104) comprising commands from a set of navigation commands for controlling the playback sequence (112) of the content (103), the set of navigation commands comprising conditional commands (110) for controlling the playback sequence (112) in a predefined way (109) depending on a precondition related to a playback status (102),
the content (103) comprising a first information (106) being freely accessible and a second information (107) being accessible dependent on the precondition in a preceding conditional command,
the player (300) comprising a reader unit (302) for reading data including the navigation structure (104) and the content (103) from the optical disc (100),
means for receiving user inputs (305) for defining the playback status (102),
a control unit (301) for receiving the data from the reader unit (302) and for combining the content (103) and the navigation structure (104) to generate the playback sequence (112),
means for recognising a preset precondition (303) being unrelated to the playback status (102), and
means for acting in a way different from the predefined way (304) upon the preceding conditional command that comprises said preset precondition (111) for controlling access to the second information (107).

9. A player (300) as claimed in claim 8, characterized in that the means for acting in a way different from the predefined way (304) comprises means for skipping or accessing the second information (107).

10. A player (300) as claimed in claim 8, characterized in that the means for acting in a way different from the predefined way (304) is further depending on a key (401).

11. A player (300) as claimed in claim 8, characterized in that the player (300) comprises means (401) for recognising an identification code (201) on the optical disc (100), the identification code indicating that the disc contains preset preconditions (111).

12. A player (300) as claimed in claim 11, characterized in that the means (401) for recognition of the identification code (201) is arranged for enabling of the means for recognising (303) the preset preconditions (111).

13. A player (300) as claimed in claim 8, characterized in that the player (300) comprises means for decryption (402) of the second information (107).

14. An optical disc recorder (500) for recording a content (103) and a navigation structure (104) onto an optical disc (100),
the navigation structure (104) comprising commands from a set of navigation commands for controlling a playback sequence (112) of the content (103), the set of navigation commands comprising conditional commands (110) for controlling the playback sequence (112) in a predefined way (109) depending on a precondition related to a playback status (102) of an optical disc player (300),
the content (103) comprising a first information (106) being freely accessible and a second information (107) being accessible dependent on the precondition in a preceding conditional command,
the optical disc recorder (500) comprising a recording unit (503) for recording data onto the optical disc (100), the data comprising the content (103) and the navigation structure (104),
a control unit (502) for receiving input data (501) comprising the content (103), and generating the navigation structure (104),
means for recognising (507) the second information (107), the control unit being arranged for including (508) a preset precondition (111) in the preceding conditional command in the navigation structure (104) for controlling access to the second information (107), the preset precondition (111) being unrelated to the playback status (102) of the optical disc player (300).

15. An optical disc recorder (500) as claimed in claim 14, characterized in that the control unit (502) is arranged for receiving input from a user (504) for defining the playback status.

16. An optical disc recorder (500) as claimed in claim 14, characterized in that the optical disc recorder (500) comprises means for encrypting (505) the second information (107).

17. An optical disc recorder (500) as claimed in claim 14, characterized in that the optical disc recorder (500) comprises means for adding (506) an identification code (401) to the optical disc (100) to indicate that the recorded disc contains preset preconditions (111).

18. Computer program product for performing a playback sequence, which program is operative to cause a processor to perform the method as claimed in claim 1.
